(19) United States
(12) Patent Application Publication
(10) Pub. No.: US 2010/0175353 A1
(43) Pub. Date: Jul. 15, 2010

(54) Magnetic Riding Shoe and Stirrup

(76) Inventor: Joseph Der, Brooklyn, NY (US)

Correspondence Address: SEAN LIAM KELLEHER;Kelleher IP PLLC, 16 PECKSLIP RD, CARMEL, NY, 10512, US

(21) Appl. No.: 12/329,953

(22) Filed: Jan. 14, 2009

(51) Int. Cl. B68C 3/00; H01F 7/00; A43B 13/00

(52) U.S. Cl. 54/49

(57) ABSTRACT

A contact system for a horse back rider allows a rider to maintain contact between their boot and the stirrup of a saddle while riding. The rider wears magnetic footwear such as a riding boot with an affixed magnet. The stirrup has a contact patch that includes a plate of ferrous metal or another magnet oriented such that it attracts the magnetic footwear. The contact patch is positioned such that it will be proximate to the magnet in the footwear when riding. During normal riding maneuvers, magnetic attractive forces between the footwear and the contact patch will maintain contact between the rider's feet and the stirrup. However, if the rider falls, the magnetic attractive forces do not bind the rider's feet to the stirrup.

### BACKGROUND OF THE INVENTION

1. Field of the Invention

The present invention relates to horseback riding accessories and more particularly to devices to maintain contact between a riders footwear and the stirrup of a saddle during maneuvers.

2. Related Art

This invention relates to a form of boot for use by horse riders. Riders in general, and those taking part in equestrian sports in particular, are in frequent danger of being thrown from their mount. The risk of bodily injury in falling from a horse is in itself rather high, and is increased by the possibility of a rider's boot becoming stuck or hung in a stirrup in the course of a fall. Such occurrences frequently result in severe injuries.

Stirrups are known for use as a foot support while riding together with a saddle on, for example, horses or other riding animals. Furthermore, use is made of a pad between the stirrup and the rider's foot to ensure good friction and shock absorption.

Several types of stirrups and pads having an upper surface with high friction against the rider's foot are available on the market. A problem with this type of stirrup is, however, that earth or clay sticking to the stirrup, the pad or the foot deteriorates the friction of the rider's foot against the stirrup. Additional problems arising in connection with existing stirrups and pads consist in positioning the foot correctly in the stirrup. This may especially be a problem to beginners, which also constitutes a security risk if the rider falls off the horse since it may be difficult for him to set himself free. It may also be difficult to dismount the horse if the rider's foot has slipped too far into the stirrup.

### SUMMARY OF THE INVENTION

An object of the present invention is to provide a system for use in connection with a stirrup while riding, which easily allows correct and safe positioning of the rider's foot relative to the stirrup.

Another object of the present invention is to provide a system that reduces the risk of the foot sliding too far into the stirrup.

The above objects and other objects that will be evident from the following description are achieved by a system according to the claims.

According to one aspect of the present invention, a footwear and stirrup contact system comprises a stirrup and footwear. At least one contact patch is affixed to the stirrup. The contact patch comprises a first material. The footwear is adapted to be worn by the rider, the footwear haves a multi-layered sole. The multi-layered sole includes a second material magnetically attracted to the first material.

### BRIEF DESCRIPTION OF THE DRAWINGS

FIG. 1 depicts a perspective view of a riding shoe and stirrup according to an embodiment of the present invention;

FIG. 2 depicts an exploded view of a first embodiment of magnetic footwear according to an embodiment of the present invention;

FIG. 3 depicts an exploded view of a second embodiment of magnetic footwear according to another embodiment of the present invention;

FIG. 4 depicts a side view of a third embodiment of magnetic footwear according to another embodiment of the present invention;

FIG. 5 depicts a base view of a fourth embodiment of magnetic footwear according to another embodiment of the present invention.

### DETAILED DESCRIPTION OF A PREFERRED EMBODIMENT OF THE INVENTION

The present invention provides a contact system for maintaining contact between a riders shoe and a stirrup. In the detailed description that follows, like element numerals are used to indicate like elements that appear in one or more of the drawings.

The contact system allows a horseback rider to maintain contact between their riding shoe and the stirrup of a saddle while riding. The rider wears magnetic footwear such as a riding shoe with a provided magnet. The stirrup has a contact patch or insert that includes a plate of ferrous metal or another magnet oriented such that it attracts the magnetic footwear. The contact patch is positioned such that it will be proximate to the magnet in the footwear when riding. During normal riding maneuvers, magnetic attractive forces between the footwear and the contact patch will maintain contact between the rider's feet and the stirrup. However, if the rider falls, the magnetic attractive forces do not bind the rider's feet to the stirrup.

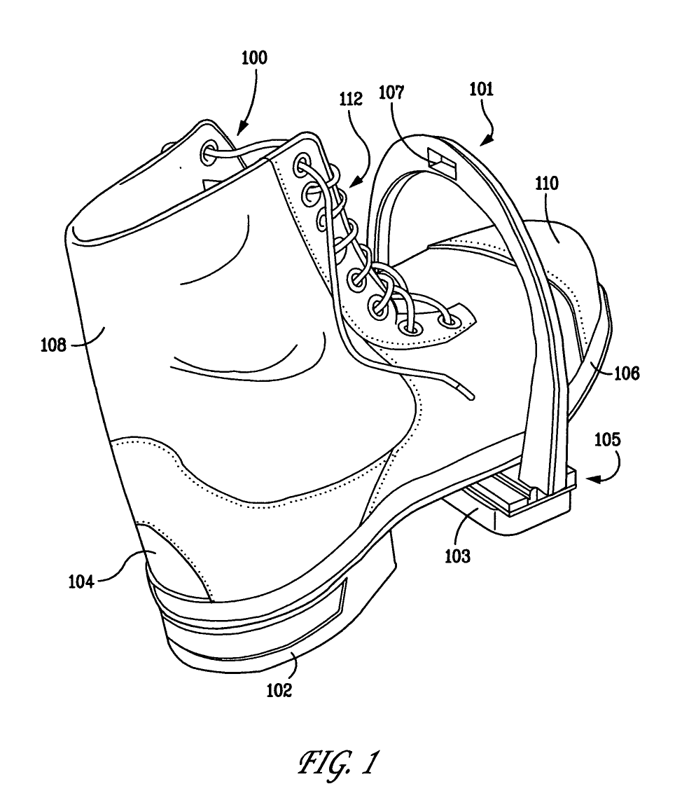

FIG. 1 depicts a perspective view of a riding shoe 100 and stirrup 101 according to an embodiment of the present invention. The riding shoe like most known footwear has an outer sole 106 which may have a tread for traction during normal walking and an extended heal 102 to prevent the riding shoe 100 from slipping through the stirrup 101 during riding. The upper portion of the riding shoe 100 may have a top extended region 108 around the wearers ankle a heal region 104 and a toe region 110. While riding shoe 100 is shown with laces 112 the laces are not necessary. Any style upper portion may be used with the present invention. The stirrup 101 attaches to the stirrup leather of a riding saddle at 107. During use the rider places their foot into the stirrup iron and rests their foot on the base 103. Base 103 has an insert 105. Insert 105 is typically rubber or other pliable material with a tread pattern to reduce slipping of the riders shoe in the stirrup. The base 105 of the present invention is either a ferrous material or a magnetic material. However, the base 105 of the present invention could have an outer layer of rubber surrounding the ferrous or magnetic material.

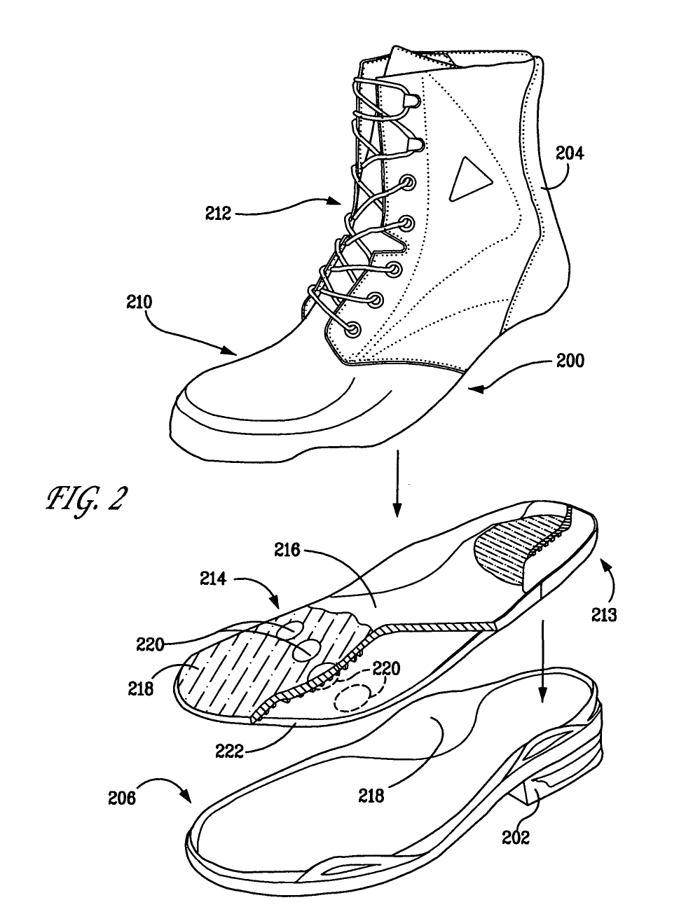

FIG. 2 depicts an exploded view of a first embodiment of magnetic footwear according to an embodiment of the present invention. The riding shoe 200 has an upper portion comprising a toe region 210, a heal region 204 and a top extended region 208. Top extended region may have laces 212, but is not required. The riding shoe 200 further has an outer sole 206 and an inner sole 213. Outer sole 206 has a heal 202 to prevent the riding shoe from slipping into the stirrup. Outer sole 206 also forms a part of the arch support for the rider's foot at 218.

Inner sole 213 comprises multiple layers of foam cloth and other materials.

An upper layer 216 is in contact with a rider's foot during use. Within the layers between upper layer 216 and a bottom layer in contact with the outer sole 206 is layer 218. Layer 218 may be any material, however, embedded in layer 218 are a series of magnets 220. Magnets 220 extend across the inner sole 213 from the ball of the foot 214 to the base of the smallest toe 222. While, the series of magnets are shown as four individual approximately round magnets, any size shape and number of magnets may be used.

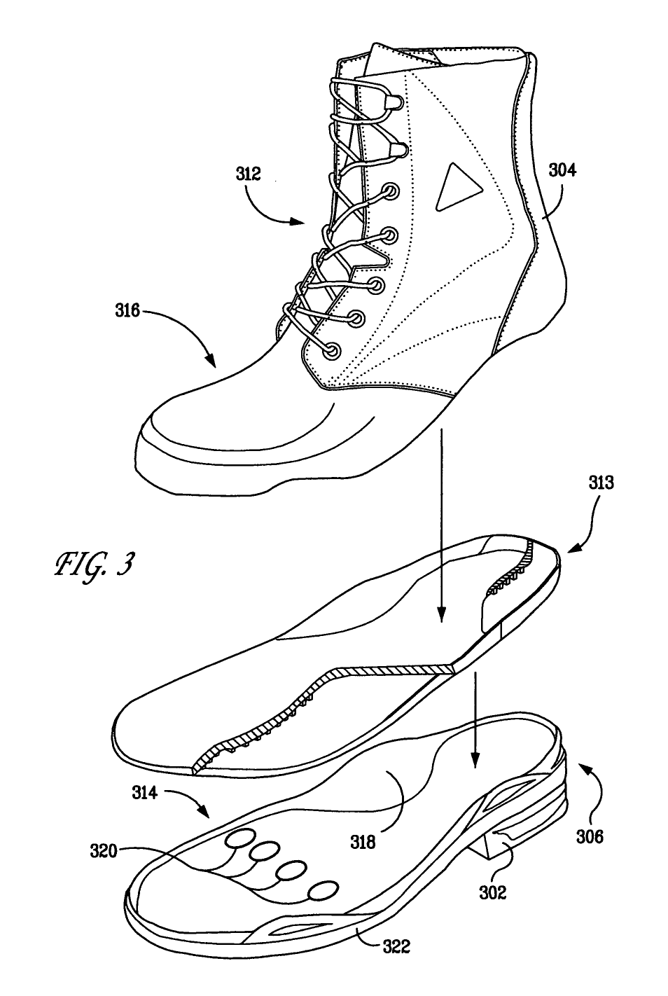

FIG. 3 depicts an exploded view of a second embodiment of magnetic footwear according to another embodiment of the present invention. The riding shoe 300 has an upper portion comprising a toe region 310, a heal region 304 and a top extended region 308. Top extended region may have laces 312, but is not required. The riding shoe 300 further has an outer sole 306 and an inner sole 313. Outer sole 306 has a heal 302 to prevent the riding shoe 300 from slipping into the stirrup. Outer sole 306 also forms a part of the arch support for the riders foot at 318.

Outer sole 306 may comprise multiple layers of foam, rubber or other materials. Inserted or embedded in outer sole 306 are a series of magnets 320. Magnets 320 extend across the outer sole 306 from the ball of the foot 314 to the base of the smallest toe 322. While, the series of magnets are shown as four individual approximately round magnets, any size shape and number of magnets may be used.

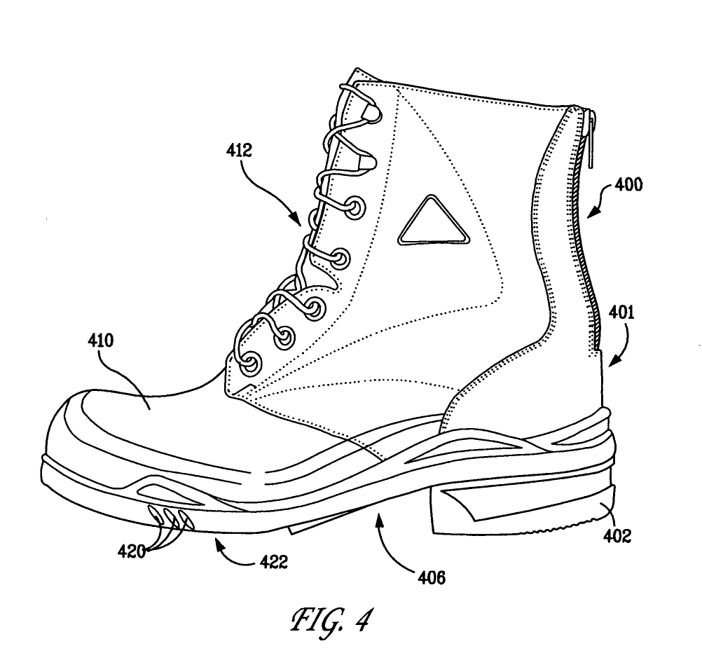

FIG. 4 depicts a side view of a third embodiment of magnetic footwear according to another embodiment of the present invention. The riding shoe 400 has an upper portion comprising a toe region 410, a heal region 404 and a top extended region 408. Top extended region may have laces 412, but is not required. The riding shoe 400 further has an outer sole 406. Outer sole 406 has a heal 402 to prevent the riding shoe 400 from slipping into the stirrup. Magnets 420 extend across the outer sole 406 from the base of the smallest toe 322 to a point approximating the ball of the foot on the opposite side. While, the series of magnets are shown as three individual magnets, any size shape and number of magnets may be used.

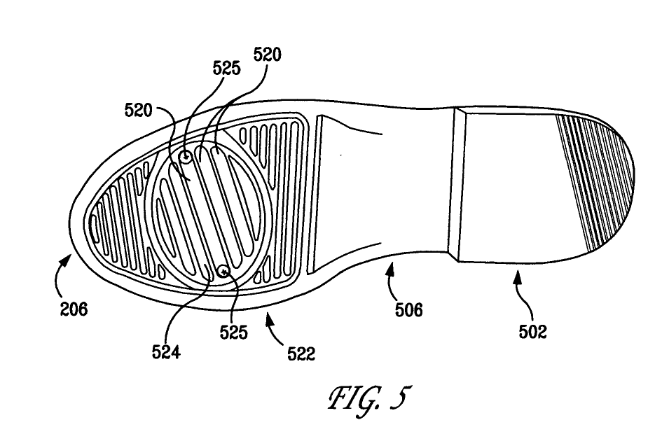

FIG. 5 depicts a base view of a fourth embodiment of magnetic footwear according to another embodiment of the present invention. The outer sole 506 has a heal portion 502, a toe portion 506 and a region corresponding to the ball of a wearer's foot 522. In the region 522 an insert 524 is placed in the bottom of the outer sole 506. Insert 524 may be attached by screws 525 or any known attaching means. On insert 524 are a series of magnets 520. The magnets 520 may be visible from the outside or embedded into the insert 524. While, the series of magnets are shown as three individual magnets, any size shape and number of magnets may be used.

Having thus described several embodiments of the riding shoe and stirrup contact system, it should be apparent to those skilled in the art that certain advantages of the system have been achieved. It should also be appreciated that various modifications, adaptations, and alternative embodiments thereof may be made within the scope and spirit of the present invention. Further, while the embodiments feature magnetic footwear and a metallic stirrup insert, a system using a magnetic layer and metallic footwear is within the spirit and scope of the present invention. The invention is solely defined by the accompanied claims.

What is claimed is:

1. A footwear and stirrup contact system comprising: a stirrup; wherein at least one contact patch is affixed to the stirrup; the at least one contact patch comprising a first material; and a footwear adapted to be worn by the rider, the footwear having a multi-layered sole; wherein the multi-layered sole includes a second material magnetically attracted to the first material.

2. The footwear and stirrup contact system of claim 1, wherein the first material is a magnetic and the second material is a material attracted to the first material.

3. The footwear and stirrup contact system of claim 2, wherein the first material comprises a rare earth magnet.

4. The footwear and stirrup contact system of claim 2, wherein the second material comprises a ferrous metal.

5. The footwear and stirrup contact system of claim 1, wherein the second material is magnetic and the first material is a material attracted to the second material.

6. The footwear and stirrup contact system of claim 2, wherein the second material comprises a rare earth magnet.

7. The footwear and stirrup contact system of claim 2, wherein the first material comprises a ferrous metal.

8. The footwear and stirrup contact system of claim 1, wherein the first material comprises a magnet and the second material comprises a magnet oriented to be mutually attracted to the other.

9. The footwear and stirrup contact system of claim 1, wherein the second material is a layer of the multi-layered sole.

10. The footwear and stirrup contact system of claim 1, wherein the second material is incorporated into a layer of the multi-layered sole.
